(19) United States
(12) Patent Application Publication
(10) Pub. No.: US 2021/0054868 A1
(43) Pub. Date: Feb. 25, 2021

(54) BILATERAL ANTI-LOOSENING AND SEALING NUT

(71) Applicant: Sumeeko Industries Co., Ltd., Kaohsiung (TW)

(72) Inventor: Kuang Yu Chen, Kaohsiung (TW)

(73) Assignee: Sumeeko Industries Co., Ltd

(21) Appl. No.: 16/848,990

(22) Filed: Apr. 15, 2020

(30) Foreign Application Priority Data
Aug. 21, 2019 (TW) 108211106

(51) Int. Cl. F16B 37/08; F16B 33/00

(52) U.S. Cl. CPC F16B 37/0892; F16B 2043/008; F16B 33/002

(57) ABSTRACT

Disclosed is a bilateral anti-loosening and sealing nut, comprising a nut body having a tapped hole with a tapped-hole thread and being surrounded by a central-wall-surrounding portion, a flange portion, a front-protruding-annular edge, a rear-recess portion, and a front-engaging portion, the front-engaging portion having an inwardly-recessed-receiving portion and an engaging-protruding edge, the inwardly-recessed-receiving portion being formed between a front surface of the central-wall-surrounding portion and a rear surface of the engaging-protruding edge; an annular washer being arranged within the inwardly-recessed-receiving portion; and a sealing washer being arranged within the rear-recess portion.

### FIELD OF THE INVENTION

The present invention relates to a nut, and more particularly relates to a bilateral anti-loosening and sealing nut.

### BACKGROUND OF THE INVENTION

In order to improve the stability of the mutual arrangement between a bolt and a nut, some nuts will be arranged with washers to reduce the risk of the bolt loosening from the nut.

One of the conventional nuts in prior art is arranged with a washer at a flange portion of the nut to increase the stability of the mutual arrangement of the bolt and the nut. However, only one end of the nut can be provided with such design to increase the stability of the mutual arrangement of the bolt and the nut, the bolt loosening still easily occurs at the other end of the nut. According to this, it is necessary to improve the design that the washer is arranged at the flange portion on a single end of the nut to increase the stability of the mutual arrangement of the bolt and the nut.

### SUMMARY OF THE INVENTION

Therefore, one objective of the present invention is to provide a bilateral anti-loosening and sealing nut to increase the stability of the mutual arrangement of the bolt and the nut on both ends of the nut.

In order to overcome the technical problems in prior art, the present invention provides a bilateral anti-loosening and sealing nut, comprising: a nut body, the nut body having a tapped hole which penetrates through the nut body, a tapped-hole middle section of the tapped hole being formed with a tapped-hole thread and being surrounded by a central-wall-surrounding portion, a flange portion being formed on a rear of the nut body, a front-protruding-annular edge being formed as protruding toward a front of the nut body, a rear-recess portion being formed between a rear surface of the central-wall-surrounding portion and a rear end of the nut body, a front-engaging portion being formed between a front surface of the central-wall-surrounding portion and a front end of the nut body, the front-engaging portion having, in a direction from rear to front, an inwardly-recessed-receiving portion and an engaging-protruding edge, the inwardly-recessed-receiving portion being formed between a front surface of the central-wall-surrounding portion and a rear surface of the engaging-protruding edge, a radial width of the inwardly-recessed-receiving portion, which is width between radial-end surfaces of the inwardly-recessed-receiving portion being greater than a radial width of the central-wall-surrounding portion and being greater than a radial width of the engaging-protruding edge; an annular washer having an outer-peripheral-abutting surface, a rear-abutting surface and a front-abutting surface, the annular washer being arranged within the inwardly-recessed-receiving portion in a manner that the outer-peripheral-abutting surface abuts the radial-end surface of the inwardly-recessed-receiving portion, the rear-abutting surface abuts the front surface of the central-wall-surrounding portion, and the front-abutting surface abuts the rear surface of the engaging-protruding edge; and a sealing washer having a central hole, an inner surface of the central hole having a sealing-washer thread, the sealing washer being arranged within the rear-recess portion of the nut body, the sealing-washer thread being provided corresponding to the tapped-hole thread of the tapped-hole middle section.

In one embodiment of the present invention, the annular washer is a nylon annular washer.

In one embodiment of the present invention, an inner wall of the rear-recess portion has, from rear to front, a buffer portion, an inwardly-protruding-withstanding portion and a recessed-withstanding portion, a distance between the inwardly-protruding-withstanding portion and a central axis of the tapped hole is less than a distance between the buffer portion and the central axis of the tapped hole, and the distance between the inwardly-protruding-withstanding portion and the central axis of the tapped hole is less than a distance between the recessed-withstanding portion and the central axis of the tapped hole.

In one embodiment of the present invention, a thread track of the sealing-washer thread of the sealing washer and a thread track of the tapped-hole thread of the tapped-hole middle section are connected in a track-continuing manner, the rear-recess portion has an annular-engaging recess, an outer-peripheral surface of the sealing washer has a corresponding-annular-engaging convex, the annular-engaging recess is in shape correspondence with the corresponding-annular-engaging convex in such a manner that the sealing washer is arranged in the rear-recess portion in an engaging manner.

In one embodiment of the present invention, the sealing washer is a nylon sealing washer.

With the technical means adopted by the present invention, a more secure connection between the bolt and the bilateral anti-loosening and sealing nut can be provided. In addition, the present invention uses the sealing washer and the annular washer to prevent the bolt from loosening, and the sealing washer is with advantage that it can block foreign objects from entering the interior of the tapped hole of the nut body by its sealing function. Furthermore, since both sides of the bilateral anti-loosening and sealing nut of the present invention are provided to have increased stability of the mutual arrangement with the bolt, even in a severe vibration situation, the bilateral anti-loosening and sealing nut can still be securely connected with the bolt and achieve the effect of sealing.

The embodiments adopted by the present invention will be further explained by the following embodiments and the attached drawings.

### BRIEF DESCRIPTION OF THE DRAWINGS

FIG. 1 is a schematic view illustrating a bilateral anti-loosening and sealing nut according to one embodiment of the present invention;

FIG. 2 is a schematic sectional view of the bilateral anti-loosening and sealing nut according to the embodiment of the present invention; and

FIG. 3 is another schematic view illustrating the bilateral anti-loosening and sealing nut according to the embodiment of the present invention;

### DETAILED DESCRIPTION OF THE PREFERRED EMBODIMENTS

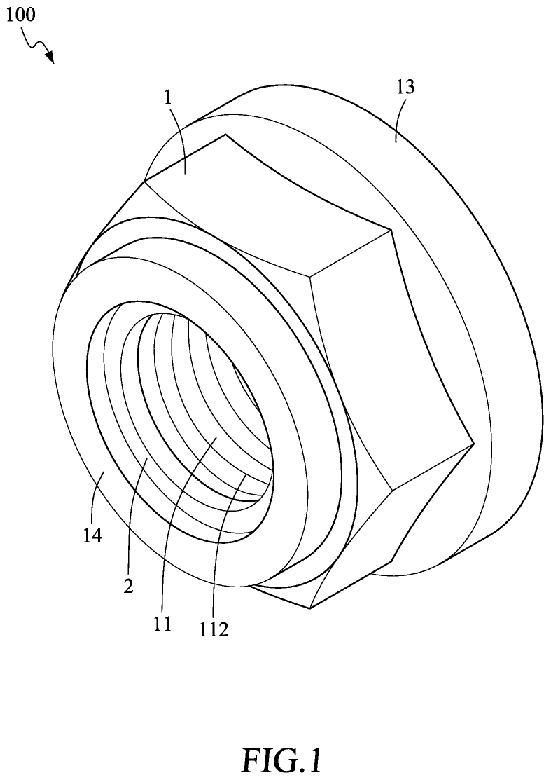

The preferred embodiments of the present invention are described in detail below with reference to FIG. 1 to FIG. 3. The description is used for explaining the embodiments of the present invention only, but not for limiting the scope of the claims.

As shown in FIG. 1 to FIG. 3, a bilateral anti-loosening and sealing nut 100 according to one embodiment of the present invention includes a nut body 1, an annular washer 2 and a sealing washer 3.

As shown in FIG. 1 to FIG. 3, in the embodiment, the bilateral anti-loosening and sealing nut 100 has a tapped hole 11, a central-wall-surrounding portion 12, a flange portion 13, a front-protruding-annular edge 14, and a rear-recess portion 15. The tapped hole 11 is formed penetrating through the nut body 1. A tapped-hole middle section 111 of the tapped hole 11 is formed with a tapped-hole thread 112 and is surrounded by the central-wall-surrounding portion 12. The front-protruding-annular edge 14 is formed as protruding toward a front of the nut body 1. In addition, the rear-recess portion 15 is formed between a rear surface of the central-wall-surrounding portion 12 and a rear end of the nut body 1. A front-engaging portion 16 is formed between a front surface of the central-wall-surrounding portion 12 and a front end of the nut body 1, wherein the front-engaging portion 16 is formed protruding from a front surface of the front-protruding-annular edge 14. Specifically, the front-engaging portion 16 has, in a direction from rear to front, an inwardly-recessed-receiving portion 161 and an engaging-protruding edge 162. The inwardly-recessed-receiving portion 161 protrudes between a front surface of the central-wall-surrounding portion 12 and a rear surface of the engaging-protruding edge 162 in an annular manner. In other words, the inwardly-recessed-receiving portion 161 protrudes at the front surface of the front-protruding-annular edge in an annular manner. Moreover, a radial width of the inwardly-recessed-receiving portion 161, which is width between radial-end surfaces 163 of an inner-wall surface of the inwardly-recessed-receiving portion 161, is greater than a radial width of an inner-wall surface of the central-wall-surrounding portion 12 and is greater than a radial width of an inner-wall surface of the engaging-protruding edge 162. The flange portion 13 is formed on a rear of the nut body 1. In detail, the flange portion 13 is arranged at an outer-peripheral edge of the rear of the nut body 1; and the rear-recess portion 15 is recessed at the center of a rear surface of the nut body 1.

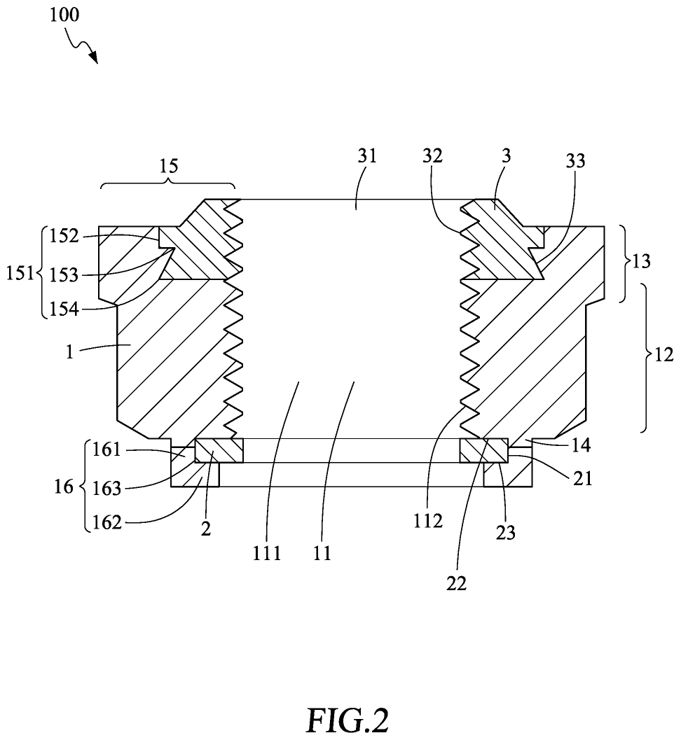

As shown in FIG. 1 and FIG. 2, the annular washer 2 of the bilateral anti-loosening and sealing nut 100 has an outer-peripheral-abutting surface 21, a rear-abutting surface 22 and a front-abutting surface 23. The annular washer 2 is arranged within the inwardly-recessed-receiving portion 161 and is blocked by the engaging-protruding edge 162 in a manner that the outer-peripheral-abutting surface 21 abuts the radial-end surface 163 of the inwardly-recessed-receiving portion 161, the rear-abutting surface 22 abuts the front surface of the central-wall-surrounding portion 12, and the front-abutting surface 23 abuts the rear surface of the engaging-protruding edge 162. Specifically, the annular washer 2 is a nylon annular washer. Certainly, the material or shape of the annular washer 2 is not limited to this, and the annular washer 2 can also be a rubber or silicon annular washer.

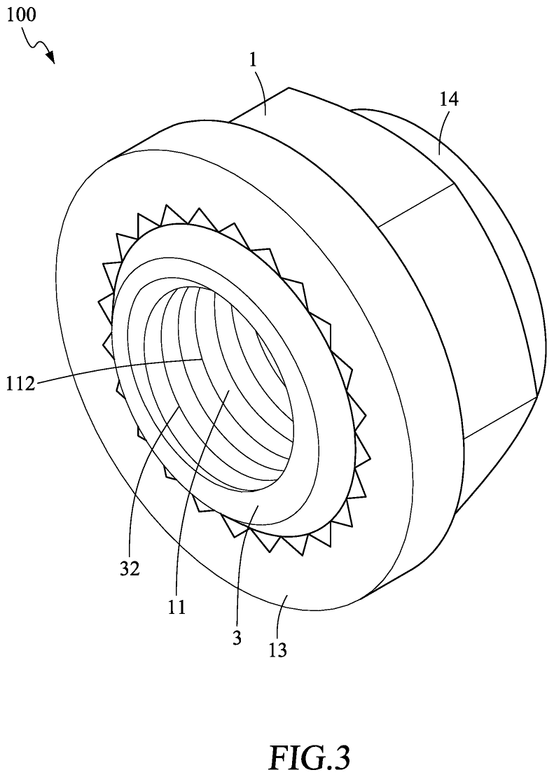

As shown in FIG. 2 and FIG. 3, the sealing washer 3 of the bilateral anti-loosening and sealing nut 100 is arranged within the flange portion 13. The sealing washer 3 has a central hole 31, and an inner surface of the central hole 31 has a sealing-washer thread 32. The sealing washer 3 is arranged within the rear-recess portion 15 of the nut body 1. The sealing-washer thread 32 is provided corresponding to the tapped-hole thread 112 of the tapped-hole middle section 111.

As shown in FIG. 2 and FIG. 3, a thread track of the sealing-washer thread 32 of the sealing washer 3 and a thread track of the tapped-hole thread 112 of the tapped-hole middle section 111 are connected in a track-continuing manner, the rear-recess portion 15 has an annular-engaging recess 151, an outer-peripheral surface of the sealing washer 3 has a corresponding-annular-engaging convex 33, and the annular-engaging recess 151 is in shape correspondence with the corresponding-annular-engaging convex 33 in such a manner that the sealing washer 3 is arranged in the rear-recess portion 15 in an engaging manner. In the embodiment, the sealing washer 3 is a nylon sealing washer. Certainly, the present invention is not limited to this, and in other embodiments, the material of the sealing washer 3 can also be made of other material, such as rubber or silicone.

As shown in FIG. 2 and FIG. 3, the annular-engaging recess 151 of the rear-recess portion 15 has, from rear to front, a buffer portion 152, an inwardly-protruding-withstanding portion 153 and a recessed-withstanding portion 154. The buffer portion 152 is a recess which is in shape correspondence with a protruding portion at the rear of the corresponding-annular-engaging convex 33 and covers an outer-edge-side surface of the protruding portion. The inwardly-protruding-withstanding portion 153 is an annular-protruding portion which is in shape correspondence with a central-outer-annular groove of the corresponding-annular-engaging convex 33 and abuts the central-outer-annular groove. The recessed-withstanding portion 154 is a receiving groove which is in shape correspondence with an annular-protruding edge of the front of the corresponding-annular-engaging convex 33 and provides an installation of the annular-protruding edge. A distance between an inner-wall surface of the inwardly-protruding-withstanding portion 153 and a central axis of the tapped hole 11 is less than a distance between an inner-wall surface of the buffer portion 152 and the central axis of the tapped hole 11, and the distance between an inner-wall surface of the inwardly-protruding-withstanding portion 153 and the central axis of the tapped hole 11 is less than a distance between an inner-wall surface of the recessed-withstanding portion 154 and the central axis of the tapped hole 11.

From the above, in the present invention, the annular washer 2 is blocked by the engaging-protruding edge 162 formed at the front-protruding-annular edge 14 so that the annular washer 2 can be stably arranged within the nut body. Also, the annular washer 2 can help to increase the contact area between the bolt and the nut so that the annular washer 2 can cooperate with the sealing washer 3 at the other end of the nut body 1 to elastically secure the bolt and the nut, thereby a more secure connection can be provided between the bolt and the bilateral anti-loosening and sealing nut. Additionally, the sealing washer 3 can not only cooperate with the annular washer 2 at the other end of the nut body 1 to prevent the bolt loosening, but the sealing washer 3 also can block foreign objects from entering the interior of the tapped hole 11 of the nut body 1 by its sealing function. Furthermore, since the annular washer 2 and the sealing washer 3 of the bilateral anti-loosening and sealing nut 100 can increase the stability of the mutual arrangement with the bolt, the bilateral anti-loosening and sealing nut 100 can still be securely connected with the bolt and achieve the effect of sealing even in a severe vibration situation.

The above description is only an explanation of the preferred embodiments of the present invention. One having ordinary skill in the art can make various modifications according to the above description and the claims defined below. However, those modifications shall still fall within the scope of the present invention.

What is claimed is:

1. A bilateral anti-loosening and sealing nut, comprising:
a nut body, the nut body having a tapped hole which penetrates through the nut body, a tapped-hole middle section of the tapped hole being formed with a tapped-hole thread and being surrounded by a central-wall-surrounding portion, a flange portion being formed on a rear of the nut body, a front-protruding-annular edge being formed as protruding toward a front of the nut body, a rear-recess portion being formed between a rear surface of the central-wall-surrounding portion and a rear end of the nut body, a front-engaging portion being formed between a front surface of the central-wall-surrounding portion and a front end of the nut body, the front-engaging portion having, in a direction from rear to front, an inwardly-recessed-receiving portion and an engaging-protruding edge, the inwardly-recessed-receiving portion being formed between a front surface of the central-wall-surrounding portion and a rear surface of the engaging-protruding edge, a radial width of the inwardly-recessed-receiving portion, which is width between radial-end surfaces of the inwardly-recessed-receiving portion being greater than a radial width of the central-wall-surrounding portion and being greater than a radial width of the engaging-protruding edge;
an annular washer having an outer-peripheral-abutting surface, a rear-abutting surface and a front-abutting surface, the annular washer being arranged within the inwardly-recessed-receiving portion in a manner that the outer-peripheral-abutting surface abuts the radial-end surface of the inwardly-recessed-receiving portion, the rear-abutting surface abuts the front surface of the central-wall-surrounding portion, and the front-abutting surface abuts the rear surface of the engaging-protruding edge; and
a sealing washer having a central hole, an inner surface of the central hole having a sealing-washer thread, the sealing washer being arranged within the rear-recess portion of the nut body, the sealing-washer thread being provided corresponding to the tapped-hole thread of the tapped-hole middle section.

2. The bilateral anti-loosening and sealing nut as claimed in claim 1, wherein the annular washer is a nylon annular washer.

3. The bilateral anti-loosening and sealing nut as claimed in claim 1, wherein an inner wall of the rear-recess portion has, from rear to front, a buffer portion, an inwardly-protruding-withstanding portion and a recessed-withstanding portion, a distance between the inwardly-protruding-withstanding portion and a central axis of the tapped hole is less than a distance between the buffer portion and the central axis of the tapped hole, and the distance between the inwardly-protruding-withstanding portion and the central axis of the tapped hole is less than a distance between the recessed-withstanding portion and the central axis of the tapped hole.

4. The bilateral anti-loosening and sealing nut as claimed in claim 1, wherein a thread track of the sealing-washer thread of the sealing washer and a thread track of the tapped-hole thread of the tapped-hole middle section are connected in a track-continuing manner, the rear-recess portion has an annular-engaging recess, an outer-peripheral surface of the sealing washer has a corresponding-annular-engaging convex, the annular-engaging recess is in shape correspondence with the corresponding-annular-engaging convex in such a manner that the sealing washer is arranged in the rear-recess portion in an engaging manner.

5. The bilateral anti-loosening and sealing nut as claimed in claim 1, wherein the sealing washer is a nylon sealing washer.
